(19) United States
(12) Patent Application Publication
(10) Pub. No.: US 2026/0071295 A1
(43) Pub. Date: Mar. 12, 2026

(54) AN ARRANGEMENT FOR AN INDURATION MACHINE OF A PELLETIZING PLANT, AN INDURATION MACHINE AND A METHOD FOR INDURATING IRON ORE PELLETS

(71) Applicant: LUOSSAVAARA-KIIRUNAVAARA AB, 971 28 (SE)

(72) Inventors: Daniel MARJAVAARA, Kiruna (SE); Christian FREDRIKSSON, LULEÅ (SE); Fredrik NORMANN, Luleå (SE); Henrik WIINIKKA, Boden (SE); Ehsan FOOLADGAR, Luleå (SE); Andreas JOHANSSON, Piteå (SE); Marcus GULLBERG, Norrfjärden (SE)

(21) Appl. No.: 19/108,713

(22) PCT Filed: Sep. 11, 2023
(86) PCT No.: PCT/SE2023/050891

§ 371 Date: Mar. 4, 2025

(30) Foreign Application Priority Data
Sep. 15, 2022 (SE) 2251070-5

(51) Int. Cl. C22B 1/24; F23D 14/22; F23D 14/58; F27D 3/16

(52) U.S. Cl. CPC C22B 1/2413; F23D 14/22; F23D 14/58; F27D 3/16; F27D 2003/164; F27D 2003/165

(57) ABSTRACT

The disclosure relates to an arrangement (1) for an induration machine (2) of a pelletizing plant (4), the arrangement (1) comprising: a furnace (6) configured for induration of iron ore pellets (8); an inlet channel (10) connected to the furnace (6), configured for supplying process gases (12) to the furnace (6); an outlet channel (14) connected to the furnace (6), configured for remove the process gases (12) from the furnace (6); and a burner (16) arranged in the inlet channel (10) configured for heating the process gases (12), wherein the burner (16) comprises: a central first burning register (18) configured for supplying hydrogen (20) as injecting fuel; at least one intermediate second burning register (22), which at least partly surrounding the central first burning register (18), and which is configured to inject oxygen (24) as an oxidizing gas to burn together with the hydrogen (20), and at least one outermost third burning register (26), which at least partly surrounding the intermediate second burning register (22), and which is configured to inject a protecting fluid (24, 32) for preventing at least a part of the process gases (12) to burn together with the hydrogen (20) and the oxygen (24) as an oxidizing gas. The disclosure further relates to an induration machine (2) and a method for indurating iron ore pellets (8) in arrangement (1) for an induration machine (2) of a pelletizing plant (4).

### TECHNICAL FIELD

The present disclosure relates to an arrangement for an induration machine of a pelletizing plant, an induration machine and a method for indurating iron ore pellets in arrangement for an induration machine of a pelletizing plant. More specifically, the disclosure relates to an arrangement for a induration machine of a pelletizing plant, an induration machine and a method for indurating iron ore pellets in arrangement for an induration machine of a pelletizing plant as defined in the introductory parts of the independent claims.

### BACKGROUND ART

Pellets are manufactured in the pelletizing plant from iron ore concentrate. In the pelletizing plant, the pellets are heated and indurated in a large furnace. There are different types of pelletizing plants—straight grate and grate-kiln plants. In the straight grate pelletizing plant, the entire process takes place on an endless conveyor belt. In the pelletizing plant, the pellets are formed, dried, pre-heated, indurated and finally cooled.

In the pelletizing plant, a clay mineral, bentonite, is added as a binder in the iron ore concentrate. Pellets are then formed to a sphere shape in large, rotating discs or drums. The pellets are thereafter transported for induration. Induration increase the strength of the pellets. In the process, large amounts of energy is used. In order for the pellets to achieve their final properties, they have to be indurated at a certain temperature, so that the iron ore particles partially melt together. After the pellets have been indurated they resist a large load, which make them suitable for transport and further handling. After induration, the pellets are cooled down and moved to storage areas before it is time for onward transport and delivery to steel producers.

At the steel producers the pellets are normally reduced in a blast furnace or a direct reduction shaft. The configuration of iron ore pellets as packed spheres in the reduction furnace allows the reduction gas to flow between the pellets. In a blast furnace, fuel (coke), iron ores, and flux are continuously supplied through the top of the furnace, while a hot blast of air is blown into the lower section of the furnace through a series of pipes, so that the chemical reactions take place throughout the furnace as the material falls downward as molten metal forming pig iron. However one of the biggest drawbacks of the blast furnace process is the inevitable carbon dioxide production as iron is reduced from iron oxides by carbon.

In the direct reduction shaft, iron ore oxide pellets are heated in a shaft furnace at a high temperature in the presence of a reducing gas whereby the pellets are reduced into metallic iron also called sponge iron or direct reduced iron (DRI). The reduction gas may consist of natural gas, a mixture of hydrogen and carbon monoxide, or preferably only hydrogen to avoid carbon dioxide emissions from the process.

Document U.S. Pat. No. 5,295,816 A, relates to a high velocity gas injection system wherein high velocity and low velocity gases are injected into a cavity in a defined relationship such that the low velocity gas forms a protective barrier from combustion zone damage due to the flow dynamics caused by the high velocity gas. The outmost burner register of the burner is used for injecting oxygen as a protecting gas surrounding injected hydrogen as fuel. The protecting oxygen surrounding the hydrogen is burned together with the injected hydrogen. Process gases supplied to the furnace are drawn into the main stream of the injected hydrogen.

EP 3 295 084 B1 describes a method for combusting gaseous or liquid fuel in an industrial furnace using a burner assembly. The method involves supplying fuel, cold primary air, and preheated air to a pre-chamber, with the pre-chamber having a length greater than its diameter. The fuel and cold primary air are supplied through a fuel feed and a primary air feed. Preheated combustion air is supplied to a downstream combustion chamber connected to the furnace.

US 2003148236 A1 concerns an ultra-low NOx burner features a fluid-based flame stabilizer and fuel staging lances to achieve a fuel-lean flame with low NOx emissions. The burner comprises three fuel staging lances surrounding the flame stabilizer, with each lance having a pipe and a staging nozzle at the end, as well as at least one hole for fuel injection. These holes possess radial and axial divergence angles designed to ensure complete circumferential coverage of the fuel-lean flame.

### SUMMARY

A problem with the solution of prior art is that the process gases supplied to the furnace is drawn into the main stream of the injected hydrogen, which together with the protecting gas is burned together with the hydrogen. A further problem with the solutions of the prior art is that the formation of nitrogen oxides (NOx) is essential. There is thus a need for an improved arrangement for an induration machine of a pelletizing plant, an induration machine and a method for indurating iron ore pellets in arrangement for an induration machine of a pelletizing plant.

It is an object of the present disclosure to mitigate, alleviate or eliminate one or more of the above-identified deficiencies and disadvantages in the prior art and solve at least the above mentioned problem.

Accordingly, it is an object of the invention to provide an arrangement for an induration machine of a pelletizing plant in which process gases supplied to the furnace are prevented from being drawn into the main stream of the injected and burning hydrogen.

It is further an object of this invention to provide an arrangement for an induration machine of a pelletizing plant in which the formation of NOx is reduced.

It is further an object of this invention to provide an induration machine, comprising the above-mentioned arrangement, in which process gases supplied to the furnace are prevented from being drawn into the main stream of the injected and burning hydrogen, and in which the formation of NOx is reduced.

It is further an object of this invention to provide a method for indurating iron ore pellets in an arrangement for an induration machine of a pelletizing plant, in which process gases supplied to the furnace are prevented from being drawn into the main stream of the injected and burning hydrogen, and in which the formation of NOx is reduced.

These objectives are achieved by an arrangement for an induration machine of a pelletizing plant according to the appended claims. These objectives are also achieved by an induration machine, comprising an arrangement according to the appended claims. Further, these objectives are also achieved by a method for indurating iron ore pellets in an arrangement for an induration machine of a pelletizing plant according to the appended claims.

According to a first aspect there is provided an arrangement for an induration machine of a pelletizing plant, the arrangement comprising: a furnace configured for induration of iron ore pellets; an inlet channel connected to the furnace, configured for supplying process gases to the furnace; an outlet channel connected to the furnace, configured for remove the process gases from the furnace; and a burner arranged in the inlet channel configured for heating the process gases, wherein the burner comprises: a central first burning register and at least one intermediate second burning register, which at least partly surrounding the central first burning register, wherein the central first burning register and at least one intermediate second burning register are configured to inject hydrogen as injecting fuel and an oxidizing gas to burn together with the hydrogen, and at least one outermost third burning register, which at least partly surrounding the intermediate second burning register, and which is configured to inject a protecting fluid for preventing at least a part of the process gases to burn together with the hydrogen and the oxidizing gas.

In such arrangement, a protective atmosphere is created by the protecting fluid, which prevents that hydrogen is burnt in contact with the process gases supplied to the furnace. Thus, in the arrangement for the induration machine of the pelletizing plant, the process gases supplied to the furnace are prevented from being drawn into the main stream of the injected and burning hydrogen. Since the burning gases are isolated from process gases, NOx is reduced during the burning process. Therefore, the formation of NOx is reduced in the arrangement for the induration machine of the pelletizing plant.

According to a second aspect there is provided an induration machine, comprising an arrangement according to the first aspect.

In this induration machine, which comprises the above-mentioned arrangement, the process gases supplied to the furnace are prevented from being drawn into the main stream of the injected and burning hydrogen, resulting in that the formation of NOx is reduced.

According to a third aspect there is provided a method for indurating iron ore pellets in arrangement for an induration machine of a pelletizing plant, wherein the arrangement comprising: a furnace configured for induration of the iron ore pellets; an inlet channel connected to the furnace, configured for supplying process gases to the furnace; an outlet channel connected to the furnace, configured for remove the process gases from the furnace; and a burner arranged in the inlet channel configured for heating the process gases, wherein the burner comprises: a central first burning register and at least one intermediate second burning register, which at least partly surrounding the central first burning register, wherein the central first burning register and at least one intermediate second burning register are configured to inject hydrogen as injecting fuel and an oxidizing gas to burn together with the hydrogen, and at least one outermost third burning register, which at least partly surrounding the intermediate second burning register, and which is configured to inject a protecting fluid for preventing at least a part of the process gases to burn together with the hydrogen and the oxidizing gas; wherein the method comprises the steps of: supplying the hydrogen as the injecting fuel and the oxidizing gas through the central first burning register and the at least one intermediate second burning register for burning the hydrogen together with the oxidizing gas in the inlet channel; and supplying the protecting fluid through the at least one outermost third burning register.

By this method, for indurating iron ore pellets in an arrangement for an induration machine of a pelletizing plant, the process gases supplied to the furnace, are prevented from being drawn into the main stream of the injected and burning hydrogen, resulting in that the formation of NOx is reduced.

Additional objectives, advantages and novel features of the invention will be apparent to one skilled in the art from the following details, and through exercising the invention. While the invention is described below, it should be apparent that the invention is not limited to the specifically described details. One skilled in the art, having access to the teachings herein, will recognize additional applications, modifications and incorporations in other areas, which are within the scope of the invention.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 schematically illustrates in a sectional view, an arrangement for an induration machine according to an example;

FIG. 2 schematically illustrates in a sectional view, arrangement for an induration machine according to an example;

FIG. 3 schematically illustrates in a sectional view, arrangement for an induration machine according to an example;

FIGS. 4 and 5 schematically illustrate in a sectional view and in a side view a burner according to an example; and

FIG. 6 shows a flowchart of a method of indurating iron ore pellets in arrangement for an induration machine of a pelletizing plant.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

According to a first aspect there is provided an arrangement for an induration machine of a pelletizing plant, the arrangement comprising: a furnace configured for induration of iron ore pellets; an inlet channel connected to the furnace, configured for supplying process gases to the furnace; an outlet channel connected to the furnace, configured for remove the process gases from the furnace; and a burner arranged in the inlet channel configured for heating the process gases, wherein the burner comprises: a central first burning register and at least one intermediate second burning register, which at least partly surrounding the central first burning register, wherein the central first burning register and at least one intermediate second burning register are configured to inject hydrogen as injecting fuel and an oxidizing gas to burn together with the hydrogen, and at least one outermost third burning register, which at least partly surrounding the intermediate second burning register, and which is configured to inject a protecting fluid for preventing at least a part of the process gases to burn together with the hydrogen and the oxidizing gas.

The arrangement may be releasable connected to the induration machine or be an integrated part of the induration machine. The pelletizing plant may be a straight grate pelletizing plant or a grate-kiln pelletizing plant. In the furnace of the induration machine, a certain temperature is generated, so that the iron ore particles in the pellets are partially melt together. The inlet channel connected to the furnace may have a straight extension and/or a curved extension. The inlet channel may have a circular cross section and/or a square cross section along its extension. The outlet channel connected to the furnace may have a straight extension and or a curved extension. The outlet channel may have a circular cross section and/or a square cross section along its extension. The inlet channel may be connected to the furnace in a first direction and the outlet channel may be connected to the furnace in a second direction. The first and second directions may be opposite to each other. The first and second directions may be arranged in an angle to each other.

A heat exchanger may be connected to the inlet channel. The heat exchanger may increase the temperature of the ambient air which passes through the heat exchanger. After the ambient air has passed through the heat exchanger, the heated ambient air is supplied to the inlet channel as process gasses. The heat exchanger may be connected to the furnace and receive heat from the furnace. Further, the heat exchanger may decrease the temperature and cool down the packed bed of pellets in the furnace. The heat exchanger may increase the temperature of the air to 150°-1100° C. dependent on which area the process gas is provided.

The burner is arranged in the inlet channel. The burner may be arranged in a wall of the inlet channel. The burner may be arranged in the inlet channel at predetermined distance from the furnace. The burner may be releasably connected to the inlet channel or be an integrated part of the inlet channel. The burner is configured to heating the process gases. The heated process gasses enter the furnace and generates heat in the furnace. The heat generated in the furnace induration the iron ore pellets, which are positioned in the furnace.

The central first burning register of the burner may have a circular or tubular configuration. The intermediate second burning register of the burner may have a circular or tubular configuration. The intermediate second burning register may be concentrically arranged around the central first burning register. The central first burning register and at least one intermediate second burning register are configured to inject hydrogen as injecting fuel and an oxidizing gas to burn together with the hydrogen. The hydrogen as injecting fuel and the oxidizing gas are configured to be injected into the inlet channel to burn together with the hydrogen. The outermost third burning register of the burner may have a circular or tubular configuration. The outermost third burning register may be concentrically arranged around the intermediate second burning register. The protecting fluid is configured to be injected through a space created between an inner wall of the outermost third burning register and an outer wall of the intermediate second burning register, and further into the inlet channel for preventing at least a part of the process gases to burn together with the hydrogen and the oxidizing gas. The central first burning register, the intermediate second burning register and the outermost third burning register may have a shape other than circular or tubular, such as square or oval cross sections.

The central first burning register may be configured for supplying hydrogen as injecting fuel, and the at least one intermediate second burning register may be configured to inject oxygen or air as an oxidizing gas to burn together with the hydrogen. Through the central first burning register hydrogen may be delivered. The hydrogen may be injected as an injecting fuel from a nozzle of the central first burning register and into the inlet channel. The intermediate second burning register of the burner may have a circular or tubular configuration. The intermediate second burning register may be concentrically arranged around the central first burning register. The oxygen or air as an oxidizing gas is configured to be injected through a space created between an inner wall of the intermediate second burning register and an outer wall of the central first burning register, and further into the inlet channel to burn together with the hydrogen.

The central first burning register may be configured to inject oxygen or air as an oxidizing gas, and the at least one intermediate second burning register may be configured for supplying hydrogen as injecting fuel, to burn together with the oxygen or air as an oxidizing gas. Through the central first burning register, oxygen or air as an oxidizing gas may be delivered. The oxygen or air as an oxidizing gas may be injected from a nozzle of the central first burning register and into the inlet channel. The intermediate second burning register of the burner may have a circular or tubular configuration. The intermediate second burning register may be concentrically arranged around the central first burning register. The hydrogen may be injected as an injecting fuel through a space created between an inner wall of the intermediate second burning register and an outer wall of the central first burning register, and further into the inlet channel to burn together with the oxygen or air as the oxidizing gas.

The arrangement comprises a precombustion chamber, in which the burner is at least partly arranged, wherein the precombustion chamber is connected to a wall of the inlet channel. The burning of hydrogen and oxygen may be implemented completely or partly in the precombustion chamber. This will prevent the process gases to take part in the burning of hydrogen and the oxidizing gas. This may reduce the formation of NOx.

A fourth burning register is surrounding the precombustion chamber, wherein the fourth burning register is configured to inject the protecting fluid directly into the inlet channel. The protecting fluid may be injected into the precombustion chamber. The protecting fluid may be injected outside the precombustion chamber and directly into the inlet channel. The protecting fluid may be injected into and also outside of the precombustion chamber. The advantage to inject the protecting fluid directly into the inlet channel from the fourth burning register surrounding the precombustion chamber is that the process gases are prevented to take part in the burning of hydrogen and oxidizing gas, which may reduce the formation of NOX.

A source of oxygen and/or water vapour as a protecting fluid is connected to the fourth burning register. The source may contain the oxygen and/or water vapour. One source may contain oxygen and another source may contain water vapour. One source of oxygen may be an electrolyzer for producing hydrogen and oxygen. The source may contain a mixture of oxygen and water vapour as a protecting fluid. The protecting fluid comprising oxygen and/or water vapour, and injected through the fourth burning register, may effectively prevent the process air to take part in the burning of hydrogen and oxidizing gas, which may reduce the formation of NOx.

The arrangement comprises a preblending device, configured for blending hydrogen as the injecting fuel and the oxidizing gas before being supplied through the central first burning register or the at least one intermediate second burning register. The preblending device may be connected to the central first burning register. The blending of hydrogen and oxidizing gas prior to igniting, may effectively burn the hydrogen and oxidizing gas.

A source of oxygen and/or water as protecting fluid is connected to the at least one third outermost burning register. The source may contain the oxygen and/or water vapour. One source may contain oxygen and another source may contain water vapour. The source may contain a mixture of oxygen and water vapour as a protecting fluid. The protecting fluid comprising oxygen and/or water vapour, and injected through the third outermost burning register, may effectively prevent the process air to take part in the burning of hydrogen and oxidizing gas, which may reduce the formation of NOx.

According to a second aspect, an induration machine is provided, comprising an arrangement as disclosed herein. The induration machine may be comprised in a pelletizing plant. In the induration machine, the process gases supplied to the furnace are prevented from being drawn into the main stream of the injected and burning hydrogen, resulting in that the formation of NOx is reduced.

The induration machine comprises a travelling grate. The pellets are loaded onto the travelling grate and form a packed bed. The temperature when the pellets entering the travelling grate is approximately in the range 20° C.-50° C. Heated process gases are blown through the bed in order to dry and fire the pellets up to a temperature in the range 1200° C.-1300° C. Thereafter the pellets are cooled down to a temperature in the range 20° C.-80° C.

According to a third aspect there is provided a method for indurating iron ore pellets in arrangement for an induration machine of a pelletizing plant, wherein the arrangement comprising: a furnace configured for induration of the iron ore pellets; an inlet channel connected to the furnace, configured for supplying process gases to the furnace; an outlet channel connected to the furnace, configured for remove the process gases from the furnace; and a burner arranged in the inlet channel configured for heating the process gases, wherein the burner comprises: a central first burning register and at least one intermediate second burning register, which at least partly surrounding the central first burning register, wherein the central first burning register and at least one intermediate second burning register are configured to inject hydrogen as injecting fuel and an oxidizing gas to burn together with the hydrogen, and at least one outermost third burning register, which at least partly surrounding the intermediate second burning register, and which is configured to inject a protecting fluid for preventing at least a part of the process gases to burn together with the hydrogen and the oxidizing gas; wherein the method comprises the steps of: supplying the hydrogen as the injecting fuel and the oxidizing gas through the central first burning register and the at least one intermediate second burning register for burning the hydrogen together with the oxidizing gas in the inlet channel; and supplying the protecting fluid through the at least one outermost third burning register.

The step of supplying the hydrogen as the injecting fuel and the oxidizing gas through the central first burning register and the at least one intermediate second burning register for burning the hydrogen together with the oxidizing gas in the inlet channel may be performed by injecting the hydrogen as an injecting fuel and the oxidizing gas from nozzles of the central first burning register and the at least one intermediate second burning register and further into the inlet channel. The step of supplying the protecting fluid through the at least one outermost third burning register may be performed by injecting the protecting fluid concentrically around the burning hydrogen and oxidizing gas. Such injection of the protecting fluid may effectively prevent the process gases to take part in the burning of hydrogen and oxidizing gas, which may reduce the formation of NOx.

The step of supplying hydrogen as the injecting fuel and the oxidizing gas through the central first burning register and the at least one intermediate second burning register for burning the hydrogen together with the oxidizing gas in the inlet channel comprises, supplying hydrogen as injecting fuel and the oxidizing gas through the central first burning register and the at least one intermediate second burning register into a precombustion chamber, which is connected to the inlet channel. The burning of hydrogen and oxidizing gas may be implemented completely or partly in the precombustion chamber by supplying hydrogen as injecting fuel through the central first burning register into a precombustion chamber. This will prevent the process gases to take part in the burning of hydrogen and oxidizing gas. This may reduce the formation of NOx. The protecting fluid may be supplied through the at least one outermost third burning register into the precombustion chamber. The protecting fluid may be injected concentrically around the burning hydrogen and oxidizing gas in the precombustion chamber. Such injection of the protecting fluid may effectively prevent the process gases to take part in the burning of hydrogen and oxidizing gas, which may reduce the formation of NOx.

The protecting fluid may be supplied outside of the precombustion chamber and in to the inlet channel. The protecting fluid may be injected outside the precombustion chamber and directly into the inlet channel. The protecting fluid may be injected into and also outside of the precombustion chamber. The advantage to inject the protecting fluid directly into the inlet channel from the fourth burning register surrounding the precombustion chamber is that the process gases are prevented to take part in the burning of hydrogen and oxidizing gas, which may reduce the formation of NOx. The protecting fluid may be injected concentrically around the burning hydrogen and oxidizing gas from the precombustion chamber. Such injection of the protecting fluid may effectively prevent the process gases to take part in the burning of hydrogen and oxidizing gas, which may reduce the formation of NOx.

The step of supplying hydrogen as the injecting fuel and the oxidizing gas through the central first burning register and the at least one intermediate second burning register for burning the hydrogen together with the oxidizing gas in the inlet channel comprises, supplying hydrogen as injecting fuel through the central first burning register and injecting oxygen or air as an oxidizing gas through the at least one intermediate second burning register. The burning of hydrogen and oxygen may be implemented completely or partly in the inlet channel or the precombustion chamber by supplying hydrogen as injecting fuel through the central first burning register into a precombustion chamber and also supplying oxygen as the oxidizing gas through the intermediate second burning register and into the precombustion chamber. This will prevent the process gases to take part in the burning of hydrogen and oxygen. This may reduce the formation of NOx.

The step of supplying hydrogen as the injecting fuel and the oxidizing gas through the central first burning register and the at least one intermediate second burning register for burning the hydrogen with the oxidizing gas in the inlet channel comprises, supplying oxygen or air as an oxidizing gas through the central first burning register and injecting hydrogen as the injecting fuel through the at least one intermediate second burning register. The burning of hydrogen and oxygen may be implemented completely or partly in the precombustion chamber by supplying hydrogen as injecting fuel through the central first burning register into a precombustion chamber and also supplying oxygen as the oxidizing gas through the intermediate second burning register and into the precombustion chamber. This will prevent the process gases to take part in the burning of hydrogen and oxygen. This may reduce the formation of NOx.

The volume of oxygen as an oxidizing gas may be supplied in relation to a volume of hydrogen to achieve over stoichiometric combustion of the hydrogen and the oxygen as an oxidizing gas. Supplying a volume of oxygen as an oxidizing gas in relation to the volume of the hydrogen, so that the combustion will be over stoichiometric leads to that any protecting fluid in the form of oxygen will not take part in the combustion. This will keep a protecting shield of protecting fluid intact. Further, the process gases will not take part in the combustion. As a result, the formation of NOx will be reduced.

Oxygen as an oxidizing gas may be supplied to the hydrogen before the hydrogen is supplied through the central first burning register. The blending of hydrogen and oxygen prior to igniting, may effectively burn the hydrogen and oxygen. A preblending device may be configured for blending hydrogen as the injecting fuel and oxygen as the oxidizing gas before being supplied through the central first burning register. The preblending device may be connected to the central first burning register.

The step of supplying the protecting fluid through the at least one outermost third burning register comprises, supplying oxygen and/or water vapour as a protecting fluid through the at least one outermost third burning register. The protecting fluid may be injected concentrically around the burning hydrogen and oxygen and form a shield around the burning hydrogen and oxygen. Such injection of the protecting fluid may effectively prevent the process gases to take part in the burning of hydrogen and oxygen, which may reduce the formation of NOx.

The step of supplying the protecting fluid through the at least one outermost third burning register comprises, supplying the oxygen and/or water vapour as protecting fluid with a velocity, which is different than a velocity of the supplied hydrogen. An increased velocity of the injected protecting fluid may increase the strength of the protecting shield of protective fluid. Such protecting shield of protective fluid prevents the process gases to take part in the combustion. As a result, the formation of NOx will be reduced. An increased velocity of the injected hydrogen may result in a more efficient burning process in which the formation of NOx is reduced. Thus, velocity of the injected protecting fluid may be higher than the velocity of the injected hydrogen. Alternatively, the velocity of the injected hydrogen may be higher than the velocity of the injected protecting fluid.

The process gases may comprise oxygen in the range of 15-21 volume % of oxygen of the total volume of process gases in order to effectively oxidizing the pellets. The oxygen may oxidize the pre-heated metal ore material into metal oxide material. Supplying oxygen as protecting fluid may increase the amount of oxygen in the process gases to and above 21 volume % of oxygen.

### Example Embodiments

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

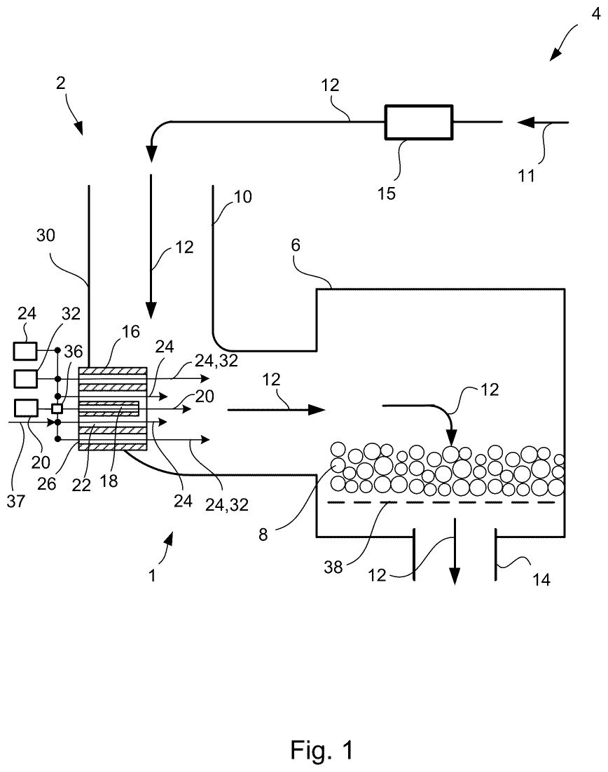

FIG. 1 schematically illustrates in a sectional view, an arrangement 1 for an induration machine 2 of a pelletizing plant 4. The arrangement 1 comprising a furnace 6 configured for induration of iron ore pellets 8. An inlet channel 10 is connected to the furnace 6, which inlet channel 10 is configured for supplying ambient air 11 to the furnace 6. A heat exchanger 15 is connected to the inlet channel 10. The heat exchanger 15 may increase the temperature of the ambient air 11, which passes through the heat exchanger 15. After the ambient air 11 has passed through the heat exchanger 15, the heated ambient air 11 is supplied to the inlet channel 10 as process gasses 12. An outlet channel 14 is connected to the furnace 6 and configured for remove the process gases 12 from the furnace 6. A burner 16 is arranged in the inlet channel 10 and is configured for heating the process gases 12. The burner 16 comprises a central first burning register 18 and an intermediate second burning register 22, which at least partly surrounding the central first burning register 18. The central first burning register 18 and the intermediate second burning register 22 are configured for supplying hydrogen 20 as injecting fuel and an oxidizing gas to burn together with the hydrogen 20. The oxidizing gas may be oxygen 24 or air. An outermost third burning register 26 is at least partly surrounding the intermediate second burning register 22, and is configured to inject a protecting fluid 24, 32 for preventing at least a part of the process gases 12 to burn together with the hydrogen 20 and the oxidizing gas. The induration machine 2 comprises a travelling grate 38.

A source of oxygen 24 and/or water vapour 32 as a protecting fluid is connected to the fourth burning register 34. The arrangement 1 comprises a preblending device 36, configured for blending hydrogen 20 as the injecting fuel and the oxidizing gas before being supplied through the central first burning register 18 and/or through intermediate second burning register 22. A source of oxygen 24 and/or water as protecting fluid is connected to the at least one third outermost burning register 26.

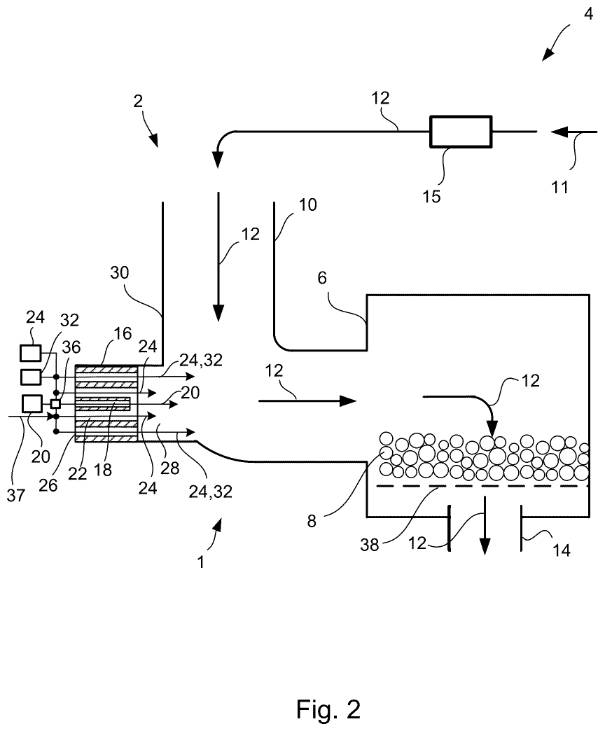

FIG. 2 schematically illustrates in a sectional view, an arrangement 1 for an induration machine 2 of a pelletizing plant 4. The arrangement 1 comprises a precombustion chamber 28, in which the burner 16 is arranged. The precombustion chamber 28 is connected to a wall 30 of the inlet channel 10.

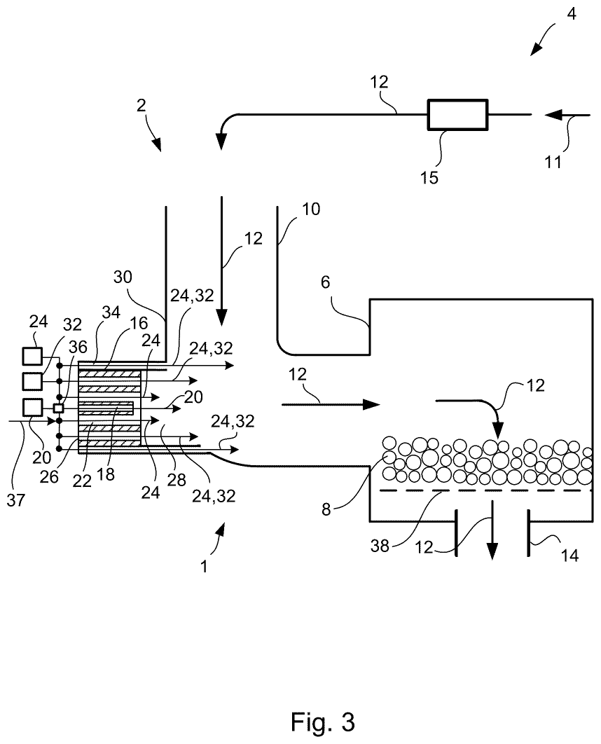

FIG. 3 schematically illustrates in a sectional view, an arrangement 1 for an induration machine 2 of a pelletizing plant 4. A fourth burning register 34 is surrounding the precombustion chamber 28, wherein the fourth burning register 34 is configured to inject the protecting fluid 24, 32 directly into the inlet channel 10.

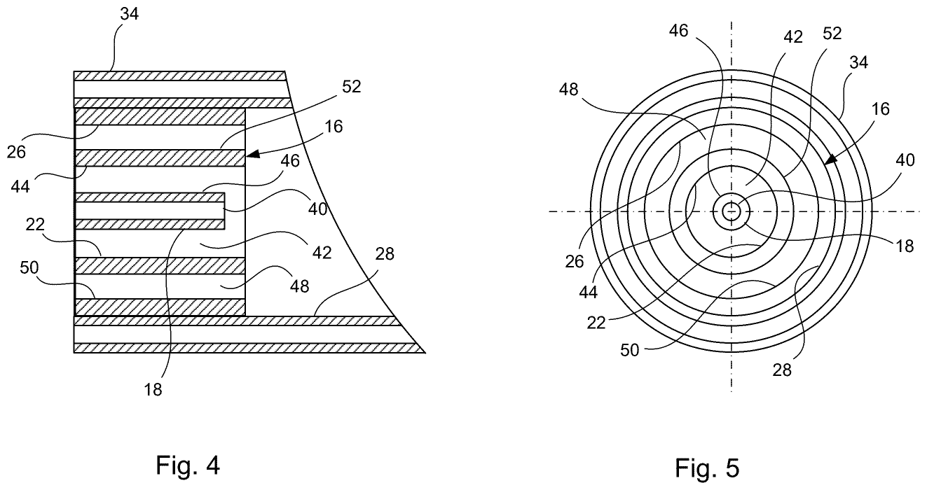

FIGS. 4 and 5 schematically illustrate in a sectional view and in a side view a burner 16. The central first burning register 18 with a circular or tubular configuration. The central first burning register 18 may comprise a nozzle 40. The intermediate second burning register 22 of the burner has a circular or tubular configuration. The intermediate second burning register 22 is concentrically arranged around the central first burning register 18. A space 42 is created between an inner wall 44 of the intermediate second burning register 22 and an outer wall 46 of the central first burning register 18. The outermost third burning register 26 of the burner 16 has a circular or tubular configuration. The outermost third burning register 26 is concentrically arranged around the intermediate second burning register 22. A space 48 is created between an inner wall 50 of the outermost third burning register 26 and an outer wall 52 of the intermediate second burning register 22. The burner 16 is arranged in the precombustion chamber 28. A fourth burning register 34 is surrounding the precombustion chamber 28.

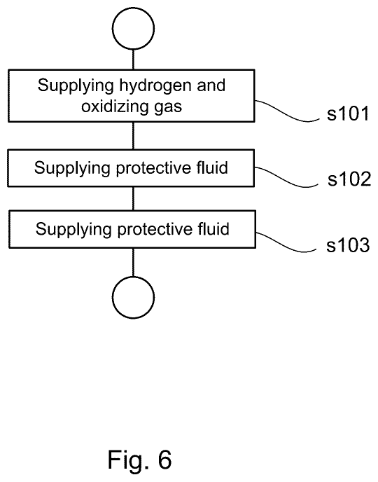

FIG. 6 shows a flowchart of a method of indurating iron ore pellets in arrangement for an induration machine of a pelletizing plant. The method relates to the arrangement 1 for an induration machine 2 of a pelletizing plant 4, described in the FIGS. 1-5. The method comprises the steps of supplying s101 the hydrogen 20 as the injecting fuel 16 and the oxidizing gas through the central first burning register 18 and the at least one intermediate second burning register 22 for burning the hydrogen 20 together with the oxidizing gas in the inlet channel 10; and supplying s102 the protecting fluid 24, 32 through the at least one outermost third burning register 26. The step of supplying s101 hydrogen 20 as the injecting fuel 16 and the oxidizing gas through the central first burning register 18 and the at least one intermediate second burning register 22 for burning the hydrogen 20 together with the oxidizing gas in the inlet channel 10 comprises, supplying hydrogen 20 as injecting fuel 16 and the oxidizing gas through the central first burning register 18 and the at least one intermediate second burning register 22 into a precombustion chamber 28, which is connected to the inlet channel 10. the method comprises the further step of supplying s103 protecting fluid 24, 32 outside of the precombustion chamber 28 and in to the inlet channel 10. The step of supplying s101 hydrogen 20 as the injecting fuel 16 and the oxidizing gas through the central first burning register 18 and the at least one intermediate second burning register 22 for burning the hydrogen 20 together with the oxidizing gas in the inlet channel 10 comprises, supplying hydrogen 20 as injecting fuel through the central first burning register 18 and injecting oxygen 24 or air as an oxidizing gas through the at least one intermediate second burning register 22. The step of supplying s101 hydrogen 20 as the injecting fuel 16 and the oxidizing gas through the central first burning register 18 and the at least one intermediate second burning register 22 for burning the hydrogen 20 together with the oxidizing gas in the inlet channel 10 comprises, supplying oxygen 24 or air as an oxidizing gas through the central first burning register 18 and injecting hydrogen 20 as the injecting fuel 16 through the at least one intermediate second burning register 22. The step of supplying s102 the protecting fluid through the at least one outermost third burning register 26 comprises, supplying oxygen 24 and/or water vapour 32 as a protecting fluid through the at least one outermost third burning register 26. The step of supplying s102 the protecting fluid through the at least one outermost third burning register 26 comprises, supplying the oxygen 24 and/or water vapour 32 as protecting fluid with a velocity, which is different than a velocity of the supplied hydrogen 20.

The foregoing description of the examples has been furnished for illustrative and descriptive purposes. It is not intended to be exhaustive, or to limit the examples to the variants described. Many modifications and variations will obviously be apparent to one skilled in the art. The examples have been chosen and described in order to best explicate principles and practical applications, and to thereby enable one skilled in the art to understand the examples in terms of its various examples and with the various modifications that are applicable to its intended use. The components and features specified above may, within the framework of the examples, be combined between different examples specified.

1-17. (canceled)

18. An arrangement for an induration machine of a pelletizing plant, the arrangement comprising:
a furnace configured for induration of iron ore pellets;
an inlet channel connected to the furnace, configured for supplying process gases to the furnace;
an outlet channel connected to the furnace, configured for remove the process gases from the furnace; and
a burner arranged in the inlet channel configured for heating the process gases, wherein the burner comprises:
a central first burning register and at least one intermediate second burning register, which at least partly surrounding the central first burning register, wherein the central first burning register is configured to inject hydrogen as injecting fuel and at least one intermediate second burning register is configured to inject an oxidizing gas to burn together with the hydrogen;
at least one outermost third burning register, which at least partly surrounding the intermediate second burning register, and which is configured to inject a protecting fluid for preventing at least a part of the process gases to burn together with the hydrogen and the oxidizing gas; and
a precombustion chamber, in which the burner is at least partly arranged, wherein the precombustion chamber is connected to a wall of the inlet channel;
wherein a fourth burning register is surrounding the precombustion chamber, wherein the fourth burning register is configured to inject the protecting fluid directly into the inlet channel.

19. The arrangement according to claim 18, wherein the central first burning register is configured for supplying hydrogen as injecting fuel, and the at least one intermediate second burning register is configured to inject oxygen or air as an oxidizing gas to burn together with the hydrogen.

20. The arrangement according to claim 18, wherein the central first burning register is configured to inject oxygen or air as an oxidizing gas, and the at least one intermediate second burning register is configured for supplying hydrogen as injecting fuel, to burn together with the oxygen or air as an oxidizing gas.

21. The arrangement according to claim 18, wherein a source of oxygen and/or water vapour as a protecting fluid is connected to the fourth burning register.

22. The arrangement according to claim 18, wherein the arrangement comprises a preblending device, configured for blending hydrogen as the injecting fuel and the oxidizing gas before being supplied through the central first burning register or the at least one intermediate second burning register.

23. The arrangement according to claim 18, wherein a source of oxygen and/or water as protecting fluid is connected to the at least one third outermost burning register.

24. An induration machine, comprising an arrangement according to claim 18.

25. The induration machine according to claim 24, wherein the machine comprises a travelling grate.

26. A method for indurating iron ore pellets in an arrangement for an induration machine of a pelletizing plant, wherein the arrangement comprising:
a furnace configured for induration of the iron ore pellets;
an inlet channel connected to the furnace, configured for supplying process gases to the furnace;
an outlet channel connected to the furnace, configured for remove the process gases from the furnace; and
a burner arranged in the inlet channel configured for heating the process gases, wherein the burner comprises:
a central first burning register and at least one intermediate second burning register, which at least partly surrounding the central first burning register, wherein the central first burning register and at least one intermediate second burning register are configured to inject hydrogen as injecting fuel and an oxidizing gas to burn together with the hydrogen, and
at least one outermost third burning register, which at least partly surrounding the intermediate second burning register, and which is configured to inject a protecting fluid for preventing at least a part of the process gases to burn together with the hydrogen and the oxidizing gas; wherein the method comprises steps of:
supplying the hydrogen as the injecting fuel and the oxidizing gas through the central first burning register and the at least one intermediate second burning register for burning the hydrogen together with the oxidizing gas in the inlet channel; and
supplying the protecting fluid through the at least one outermost third burning register
supplying protecting fluid through a fourth burning register outside of a precombustion chamber and in to the inlet channel.

27. The method according to claim 26, wherein the step of supplying hydrogen as the injecting fuel and the oxidizing gas through the central first burning register and the at least one intermediate second burning register for burning the hydrogen together with the oxidizing gas in the inlet channel comprises, supplying hydrogen as injecting fuel and the oxidizing gas through the central first burning register and the at least one intermediate second burning register into a precombustion chamber, which is connected to the inlet channel.

28. The method according to claim 26, wherein the step of supplying hydrogen as the injecting fuel and the oxidizing gas through the central first burning register and the at least one intermediate second burning register for burning the hydrogen together with the oxidizing gas in the inlet channel comprises, supplying hydrogen as injecting fuel through the central first burning register and injecting oxygen or air as an oxidizing gas through the at least one intermediate second burning register.

29. The method according to claim 26, wherein the step of supplying hydrogen as the injecting fuel and the oxidizing gas through the central first burning register and the at least one intermediate second burning register for burning the hydrogen together with the oxidizing gas in the inlet channel comprises, supplying oxygen or air as an oxidizing gas through the central first burning register and injecting hydrogen as the injecting fuel through the at least one intermediate second burning register.

30. The method according to claim 26, wherein the step of supplying the protecting fluid through the at least one outermost third burning register comprises, supplying oxygen and/or water vapour as a protecting fluid through the at least one outermost third burning register.

31. The method according to claim 29, wherein the step of supplying the protecting fluid through the at least one outermost third burning register comprises, supplying the oxygen and/or water vapour as protecting fluid with a velocity, which is different than a velocity of the supplied hydrogen.
